(19) United States
(12) Patent Application Publication
(10) Pub. No.: US 2006/0044286 A1
(43) Pub. Date: Mar. 2, 2006

(54) Method and apparatus for liquid crystal displays

(76) Inventors: John T. Kohlhaas, Las Vegas, NV (US); Stefan Sinn, Las Vegas, NV (US); Eduard Sinn, Henderson, NV (US)

Correspondence Address: PRESTON GATES ELLIS & ROUVELAS MEEDS LLP, 1735 NEW YORK AVENUE, NW, SUITE 500, WASHINGTON, DC, 20006, US

(21) Appl. No.: 11/210,745

(22) Filed: Aug. 25, 2005

Related U.S. Application Data
(60) Provisional application No. 60/604,008, filed on Aug. 25, 2004.

(51) Int. Cl. G09G 5/00

(52) U.S. Cl. 345/173

(57) ABSTRACT

A mobile computer may comprise a notebook computer base, a transparent Liquid Crystal Display (LCD) configuration, and a removable multi-function wireless digitizer tablet. A notebook computer base may contain electronic components that can store, retrieve, and process data; and wireless communication circuitry. A transparent LCD configuration is comprised of a liquid crystal display (LCD) panel having preset display characteristics, such as image brightness and contrast. A removable multi-function wireless digitizer tablet may comprise a digitizer tablet; wireless communication circuitry; a magnetic stripe reader, batteries, various types of cameras, an enclosure, and mobile computer navigation/control functions.

This application claims the benefit, under 35 U.S.C. §119, of provisional U.S. Application Ser. No. 60/604,008, filed 25 Aug. 2004, the entire contents and substance of which is hereby incorporated by reference.

### FIELD OF THE INVENTION

The present invention relates to novel systems, methods, and apparatus useful for achieving a more functional mobile computer.

The present invention further relates to novel systems, methods, and apparatus useful for Liquid Crystal Display(s) (LCD(s)) which optimally utilize ambient light to illuminate the display.

### BACKGROUND OF THE INVENTION

The present invention relates to novel systems, methods, and apparatus useful for achieving a more functional mobile computer, and in particular, a more functional Liquid Crystal Display (LCD) configuration, and in particular, a more functional digitizer tablet. The transparent LCD configuration, in particular, displays an image on a first viewing side and a second viewing side such that the image is simultaneously viewable by viewers situated on opposite sides of the display device, and in particular, the display device optimally utilizes ambient light to illuminate the display. The digitizer tablet, in particular, is a detachable multi-function wireless digitizer tablet.

A notebook computer, commonly referred to as a laptop, is a battery-or Alternating Current-powered computer generally smaller than a briefcase that can easily be transported and conveniently used in temporary spaces. Typically, a LCD is coupled with a notebook computer base to display images. A notebook computer base may contain electronic components that can store, retrieve, and process data; and wireless communication circuitry.

Notebook computers with integrated digitizer tablet functions are referred to as tablet computers. Today's tablet computers implement a display that doubles as a digitizer tablet. The digitizer tablet allows the user to use a stylus like a pen where the digitizer tablet records the information. Windows®/Linux-like software is available for such tablet computers. Today's tablet computers, including slate tablet computers and convertible tablet computers, can be converted into a more typical notebook computer configuration, including a keyboard. Thus, a user may choose between a keyboard, mouse, and digitizer tablet for input.

Furthermore, today's tablet computers combine the digitizer tablet and the screen by positioning the digitizer tablet behind the display within the display enclosure. The positioning of the digitizer tablet behind the display allows the user to use the stylus directly on the display wherein the digitizer tablet captures the input from the stylus. This configuration limits a user because the digitizer tablet is bound to the display. Digitizer tablets, in particular digitizer tablets associated with today's tablet computers lack the ability to uncouple the digitizer tablet from the display, and in particular, lack wireless communication circuitry to interact with the tablet computer when uncoupled. Furthermore, today's LCDs, in particular those associated with notebook and tablet computers lack a transparent display configuration wherein an image may be viewed from both sides of a single LCD simultaneously.

By way of background, U.S. Pat. No. 5,856,819 relates to a bi-directional presentation display device for displaying an image visible to an audience on both sides of the display device. The display device has a pair of screens, each defining an image surface which faces in generally opposite directions relative to one another.

Next, for example, U.S. Pat. No. 6,744,481 relates to a liquid crystal display panel (LCD) having display capability on both sides. The LCD comprises a liquid crystal module, a first front polarizer, a first rear polarizer, a first reflector, a second front polarizer, a second rear polarizer, and a second reflector. By replacing a portion of the original front polarizer with the first rear polarizer and the first reflector, and replacing a portion of the original rear polarizer and the original reflector with the first front polarizer, the LCD having display capability on both sides is said to be attained.

Additionally, U.S. Pat. No. 5,793,360 teaches a digitizer eraser system and method to include a writing/erasing digitizer pen, a tablet, and a tablet driver for use in conjunction with a computer and corresponding display screen. In this system, the user selects and deletes text or cells with one stylus stroke. In one motion, the user presses select, moves the erasing stylus across the material to be selected, then at the end of the selection lifts the stylus off the tablet to delete or erase the selected material. The system permits erasing of text or objects from the display screen via a keystroke function only when predetermined cursor shapes are being used on the screen. The keystroke function is chosen from a group of possible erasing keystrokes, with the selected keystroke being based upon the cursor shape being used so that undesirable erasing keystrokes are not used in certain situations. Additionally, the cursor shapes displayed on the screen are changed in accordance with whether the stylus is in writing or an erasing mode or position. The patent provides a good discussion of the prior art on digitizer tablets.

Finally, U.S. Pat. No. 6,542,145 relates to a self-illuminating LCD screen device containing an LCD module with a first polarizer layer, a first transparent substrate, a first transparent electrode layer, a liquid crystal layer, a second transparent electrode layer, a second transparent substrate and a second polarizer layer, and containing an Light Emitting Diodes (LED) module for illuminating the LCD module, having a third transparent electrode layer, a layer containing organic light-emitting materials, a fourth electrode layer and a substrate as well as, if appropriate, further layers contained between the third and fourth electrode layer.

Thus, a need exists for an improved LCD device, particularly a LCD configuration comprising a transparent screen, which displays an image on a first viewing side and a second viewing side such that the image is simultaneously viewable by viewers situated on opposite sides of the display device and a display device which optimally utilizes ambient light to illuminate the display.

Furthermore, there is a need for a digitizer tablet which is separable from a display device on a notebook or tablet computer. There is a further need for a digitizer tablet which may communicate through wireless mode with a host mobile computer.

What is further needed is an transparent LCD configuration for notebook/tablet computer, cellular phone, computer laptop, personal digital assistant or other accessories including, but not limited to, cash registers, store windows, and electronic games benefiting from a transparent screen which displays an image viewable from opposing sides and a device which optimally utilizes ambient light to illuminate the display.

### SUMMARY OF THE INVENTION

Accordingly, the present invention relates to novel systems, methods, and apparatus to provide a more functional mobile computer, and in particular, a more functional LCD configuration, and in particular, a more functional digitizer tablet. A mobile computer may comprise a notebook computer base, a transparent LCD configuration, and a removable multi-function wireless digitizer tablet. The transparent LCD configuration, in particular, displays an image on a first viewing side and a second viewing side such that the image is simultaneously viewable by viewers situated on opposite sides of the display device, and in particular, the display device optimally utilizes ambient light to illuminate the display. The digitizer tablet, in particular, is a detachable multi-function wireless digitizer tablet allowing users to interact with the host mobile computer from a measurable distance.

In one aspect of the present invention, a more functional mobile computer is provided that includes a notebook computer base coupled with a transparent LCD configuration, for example, with a hinge mechanism allowing the transparent LCD configuration to open and close, wherein the transparent LCD configuration may be simultaneously coupled with a removable multi-function wireless digitizer tablet, wherein the removable multi-function wireless digitizer tablet may be attached to the back of the transparent LCD configuration. The said configuration may resemble a typical notebook computer, or may resemble a typical convertible tablet computer when the convertible tablet computer is positioned to resemble a notebook computer.

In a second aspect of the present invention, a mobile computer is provided that includes a notebook computer base coupled with a transparent LCD, wherein the transparent LCD is coupled with a removable multi-function wireless digitizer tablet, wherein the removable multi-function wireless digitizer tablet is positioned between the notebook computer base and the transparent LCD. The said configuration may resemble a typical slate tablet computer or may resemble a typical convertible tablet computer when the convertible tablet computer is positioned to resemble a slate tablet computer.

In a third aspect of the present invention, a mobile computer is provided that includes a notebook computer base coupled with a transparent LCD, wherein the removable multi-function wireless digitizer tablet is detached from the transparent LCD and detached from the computer base. The removable multi-function wireless digitizer tablet may communicate with the computer base via wireless circuitry located within the removable multi-function wireless digitizer tablet and the notebook computer base.

In a fourth aspect of the present invention, a transparent LCD configuration is provided. In one embodiment the transparent LCD may comprise a first enclosure such as a clear, Lexan-like enclosure, a first polarizer retardation film with half wave mirror with the mirror reflectance from 15 to 60 percent such as a polarizer retardation film as manufactured by Advanced Link Photonics (ALP), Inc. (Irvine, Calif.), a first diffusion surface or diffractive surface or element with surface haze between 0 to 30 percent, a first optical grade plastic with Cold Cathode Florescent Lamp (CCFL) or Light Emitting Diodes (LEDs) surrounding the circumference of the optical grade plastic, a second diffusion surface with surface haze between 0 to 60 percent, a first transflective film such as a transflective film as manufactured by ALP, Inc., a LCD panel, a second transflective film such as a transflective film as manufactured by ALP, Inc., a third diffusion surface with surface haze between 0 and 60 percent, a second optical grade plastic with Cold Cathode Florescent Lamp (CCFL) or Light Emitting Diodes (LEDs) surrounding the circumference of the optical grade plastic, a fourth diffusion surface or diffractive surface or element with surface haze between 0 and 30 percent, a second polarizer retardation film with half wave mirror with the mirror reflectance between 15 and 60 percent such as a polarizer retardation film as manufactured by ALP, Inc., and a second enclosure such as a clear, Lexan-like enclosure.

In a specific embodiment, the transparent screen may be illuminated by ambient light, by a backlight, by illumination sources on the frame of the screen, or by a combination of any of the light sources indicated earlier.

In another aspect, one or more photo sensors are connected to driver circuitry and the driver circuitry varies default lighting settings provided with the screen or user-adjustable brightness settings for the screens in accordance with the amount of ambient light detected by one or more photo sensors by adjusting the illumination provided by the backlight. The transparent screen further comprises one or more photo sensors wherein the photo sensors are located at different positions on the transparent screen and may be located adjacent to the edges of the transparent screen. The photo sensors may be located on both sides of the transparent screen. The transparent LCD configuration comprises a control system for processing of signals from the photo sensors. The photo sensors generate an analog voltage signal proportional to the amount of ambient light; the photo sensors generate a higher voltage signal if the screen is used outdoors under the sun on a sunny day than if the screen is used outdoors on a cloudy day or is used indoors. The control system may further comprise an analog-to-digital converter which converts the analog signal from the photo sensor to a digital signal and the digital signal is transmitted to the control system which is coupled electrically to the photo sensors. If more than one of the photo sensors are used, a single output photo sensor voltage signal is generated by combining the several voltage signals of the more than one photo sensors by computing the average, root mean square or any other user-determined value and the output photo sensor voltage signal is then compared against a reference voltage value set by default lighting settings or user-adjustable brightness or contrast settings for the transparent screen. If the output photo sensor voltage signal exceeds the reference voltage value, the control system sends an output signal to the back lighting assembly to reduce the illumination of the transparent screen. If the output photo sensor voltage signal is lower than the reference voltage value, the control system sends an output signal to increase the illumination of the transparent screen.

In a fifth aspect of the present invention, a transparent LCD configuration is provided, in particular, the transparent LCD configuration displays an image on a first viewing side and a second viewing side such that the image is simultaneously viewable by viewers situated on opposite sides of the display device. In one embodiment electronic video and control signals may be received from a system, including but not limited to a computer system, and transmitted through a device driver to the transparent LCD. In another embodiment, the image on the screen may be flipped around the vertical axis. The image reformatting including changes in dimensions and orientation may be accomplished by the device driver(s).

LCDs in use may be back-lit LCDs or front-lit LCDs. In back-lit LCDs, the light source directed through the LCD is a back-light assembly assembled behind the display; back lighting generally provides a more uniform image. A front-lit LCD, on the other hand, comprises a reflector assembled behind the LCD which reflects ambient light from reaching the reflector through the LCD. Some LCDs may utilize ambient light to illuminate the display and make visible the images created by the LCD.

In a sixth aspect of the present invention, a transparent LCD configuration is provided, wherein the transparent LCD configuration may utilize a CCFL as an artificial light source, wherein the emitted light will pass through a first optical grade plastic (wave-guide) 110 followed by a first diffusion surface 100 to provide even light reflection and diffusion, a second diffusion surface 120 for uniform light distribution throughout the active screen area of the LCD panel 140, a first transflective film 130 for enhanced ambient light illumination, and an LCD panel 140. A first polarizer retardation film with half wave mirror 90 is positioned away from the LCD panel 140 adjacent to the first diffusion surface 100, wherein the first polarizer retardation film 90 serves the function of blocking the reflected light from the first diffusion surface 100, the first optical grade plastic 110, the second diffusion surface 120, and the first transflective film 130, wherein the identical process is repeated on the opposing side of the LCD panel 140. The opposing side of the LCD panel may utilize a CCFL as an artificial light source, wherein the emitted light will pass through a second optical grade plastic (wave-guide) 170 followed by a fourth diffusion surface 180 to provide even light reflection and diffusion, a third diffusion surface 160 for light uniformity throughout the active screen area of the LCD panel 140, a second transflective film 150 for enhanced ambient light illumination, and an LCD panel 140. A second polarizer retardation film with half wave mirror 190 is positioned away from the LCD panel 140 adjacent to the fourth diffusion surface 180, wherein the second polarizer retardation film 190 serves the function of blocking the reflected light from the fourth diffusion surface 180, the second optical grade plastic 170, the third diffusion surface 160, and the second transflective film 150.

In a seventh aspect of the present invention, a transparent LCD configuration is provided, in particular, the transparent LCD configuration may optimally utilize ambient light to illuminate the display, wherein the emitted ambient light will pass through the first polarizer retardation film 90 followed by a first diffusion surface 100 to provide the initial light diffusion, the first optical grade plastic 110, followed by a second diffusion surface 120 for uniform light distribution throughout the active screen area of the LCD panel 140, a first transflective film 130 for enhanced ambient light illumination, and an LCD panel 140. The first polarizer retardation film with half wave mirror 90 is positioned away from the LCD panel 140 adjacent to the first diffusion surface 100, wherein the first polarizer retardation film 90 serves the function of blocking the reflected light from the first diffusion surface 100 , the first optical grade plastic 110, the second diffusion surface 120, and the first transflective film 130, wherein, the first polarizer retardation film with half wave mirror allows transmissive passage of ambient light, wherein the identical process is repeated on the opposing side of the LCD panel 140. The opposing side of the LCD panel may optimally utilize ambient light to illuminate the display, wherein the emitted ambient light will pass through the second polarizer retardation film 190 followed by the fourth diffusion surface 180 to provide the initial light diffusion, the second optical grade plastic 170, a third diffusion surface 160 for uniform light distribution throughout the active screen area of the LCD panel 140, a second transflective film 150 for enhanced ambient light illumination, and an LCD panel 140. The polarizer retardation film with half wave mirror 190 is positioned away from the LCD panel 140 adjacent to the fourth diffusion surface 180, wherein the second polarizer retardation film 190 serves the function of blocking the reflected light from the fourth diffusion surface 180, the second optical grade plastic 170, the third diffusion surface 160, and the second transflective film 150, wherein, the second polarizer retardation film with half wave mirror allows transmissive passage of ambient light.

In an eighth aspect of the present invention, a removable multi-function wireless digitizer tablet is provided. In one embodiment, the removable multi-function wireless digitizer tablet may comprise a digitizer tablet, wireless communication circuitry; a magnetic stripe reader, batteries, various types of cameras, an enclosure, and mobile computer navigation/control functions. The removable multi-function wireless digitizer tablet may be coupled with a stylus to provide the user with wireless control of the host mobile computer to perform any variety of functions, including but not limited to: host mobile computer navigation and control; capturing information in the user's own handwriting; point-of-sale credit/debit card processing; and audio/video capture.

In a ninth aspect of the present invention, the transparent LCD configuration comprising one or more photo sensors. The photo sensors may be located at different positions on the transparent screen. The photo sensors may be located adjacent to the edges of the transparent screen and on both sides of the transparent screen. The transparent LCD configuration further comprises a control system for processing of signals from the photo sensors. The control system may comprise an analog-to-digital converter which converts the analog signal from the photo sensors to a digital signal.

### BRIEF DESCRIPTION OF THE DRAWINGS

FIG. 1 shows one embodiment of the present invention. A mobile computer wherein the removable multi-function wireless digitizer tablet is attached to the rear of the transparent LCD configuration, wherein the transparent LCD configuration is secured to the notebook computer base. The said configuration resembles a typical notebook computer.

FIG. 2 shows one embodiment of the present invention. A mobile computer is provided that includes a notebook computer base is coupled with a transparent LCD, wherein the transparent LCD is coupled with the removable multi-function wireless digitizer tablet, wherein the removable multi-function wireless digitizer tablet is positioned between the notebook computer base and the transparent LCD. The said configuration may resemble a typical slate tablet computer or may resemble a typical convertible tablet computer when the convertible tablet computer is positioned to resemble a slate tablet computer.

FIG. 3 shows one embodiment of the present invention. A mobile computer is provided that includes a removable multi-function wireless digitizer tablet attached to the rear of the transparent LCD configuration. The said configuration resembles a typical notebook computer.

FIG. 4 shows one embodiment of the present invention. A mobile computer is provided that includes a removable multi-function wireless digitizer tablet attached to the rear of a transparent LCD configuration and additionally shows a CD/DVD drive located within the notebook computer base. The said configuration resembles a typical notebook computer.

FIG. 5 shows one embodiment of the present invention. A mobile computer is provided that includes a notebook computer base coupled with a translucent/transparent LCD, wherein the removable multi-function wireless digitizer tablet is detached from the transparent LCD and detached from the computer base. The removable multi-function wireless digitizer tablet may communicate with the computer base via wireless circuitry located within the removable multi-function wireless digitizer tablet and the notebook computer base. In this embodiment the removable multi-function wireless digitizer tablet is detached from the back of the transparent LCD configuration exposing the backside of the transparent LCD configuration, wherein the transparent LCD configuration displays an image on a first viewing side and a second viewing side such that the image is simultaneously viewable by viewers situated on opposite sides of the display device, wherein the viewed image may be inverted around a vertical axis.

FIG. 6 shows one embodiment of the present invention. A mobile computer is provided that includes a removable multi-function wireless digitizer tablet is detached from the rear of the transparent LCD configuration. The removable multi-function wireless digitizer tablet appears in front of the notebook computer base and illustrates an integrated magnetic stripe reader for credit/debit card processing and a stylus. Furthermore a CD/DVD drive is shown integrated into the notebook computer base.

FIG. 7 shows one embodiment of the present invention. A cross-sectional view of the LCD configuration is provided.

### DETAILED DESCRIPTION OF THE PREFERRED EMBODIMENT

It is to be understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. All references cited herein are incorporated by reference herein in their entirety.

“Transparent” is defined as any material having the property of being able to transmit and diffuse light passing through the material so that objects can be seen through the material in varying, and preferably controlled, degrees of clarity. “Transparent” includes the term “translucent” defined as any material having the property of transmitting and diffusing light so that objects beyond cannot be seen clearly.

“Transmitting” is defined as the means to send or convey from one person or place to another.

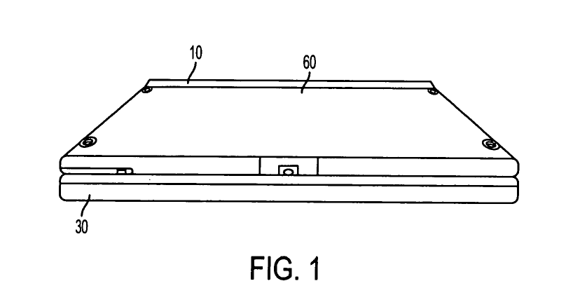

Referring to the figures, FIG. 1 shows one embodiment of the present invention. A mobile computer is shown wherein a notebook computer base is coupled with a transparent LCD configuration, wherein the removable multi-function wireless digitizer tablet is simultaneously attached to the back of the transparent LCD configuration, wherein the positioning of the mobile computer resembles a typical notebook computer. In this embodiment the removable multi-function wireless digitizer tablet 60, may be magnetically coupled with the back of the transparent LCD configuration 20 and may provide backlight illumination enhancement when not used in a fashion that allows viewing from both sides of the display.

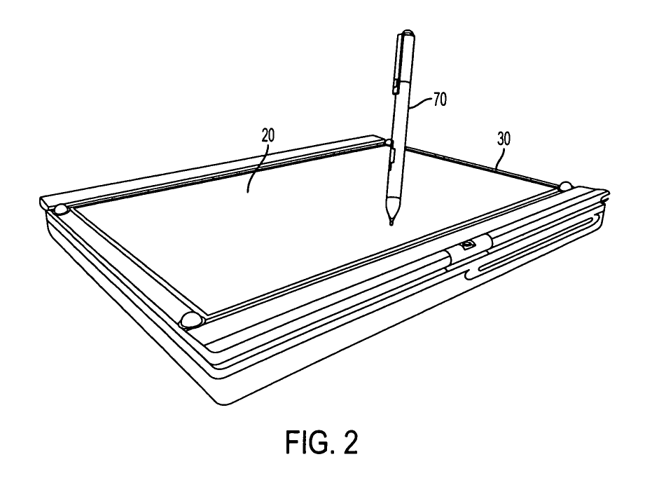

FIG. 2 shows another embodiment of the present invention. A mobile computer is shown that includes a notebook computer base 30 coupled with a transparent LCD configuration 20, wherein the transparent LCD configuration 20 is coupled with the removable multi-function wireless digitizer tablet 60, wherein the removable multi-function wireless digitizer tablet 60 is positioned between the notebook computer base and the transparent LCD configuration 20. In this embodiment a user may apply the stylus directly on the transparent LCD configuration 20, wherein the removable multi-function wireless digitizer tablet 60 collects the stylus input data through the LCD. The said configuration may resemble a typical slate tablet computer or may resemble a typical convertible tablet computer when the convertible tablet computer is positioned to resemble a slate tablet computer. In this embodiment the removable multi-function wireless digitizer tablet 60, may be magnetically coupled with the notebook computer base 30 and the front of the transparent LCD configuration 20, wherein the removable multi-function wireless digitizer tablet 60 may provide backlight illumination enhancement when not used in a fashion that allows viewing from both sides of the display.

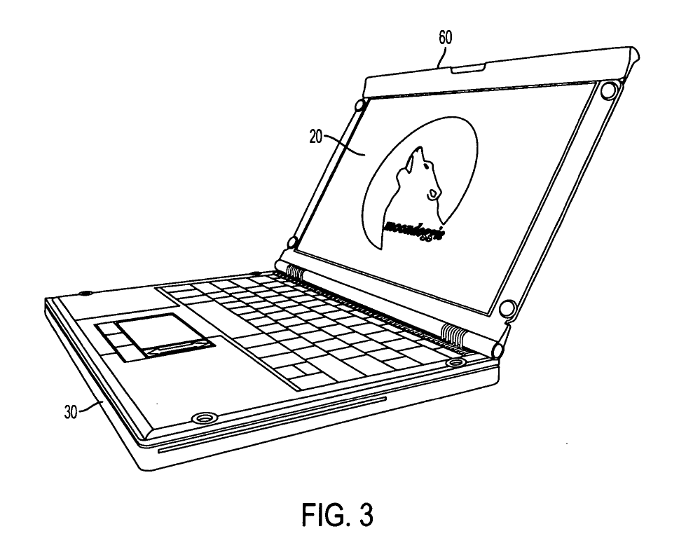

FIG. 3 shows another embodiment of the present invention. A mobile computer is shown that includes a notebook computer base 30 coupled with the transparent LCD configuration 20, for example with a hinge mechanism allowing the transparent LCD configuration 20 to open and close, wherein the transparent LCD configuration 20 may be simultaneously coupled with a removable multi-function wireless digitizer tablet 60, wherein the removable multi-function wireless digitizer tablet 60 may be attached to the back of the transparent LCD configuration 20. The said configuration may resemble a typical notebook computer, or may resemble a typical convertible tablet computer when the convertible tablet computer is positioned to resemble a notebook computer. In this embodiment the removable multi-function wireless digitizer tablet 60, may be magnetically coupled with the back of the transparent LCD configuration 20, wherein the removable multi-function wireless digitizer tablet 60 may provide backlight illumination enhancement when not used in a fashion that allows viewing from both sides of the display.

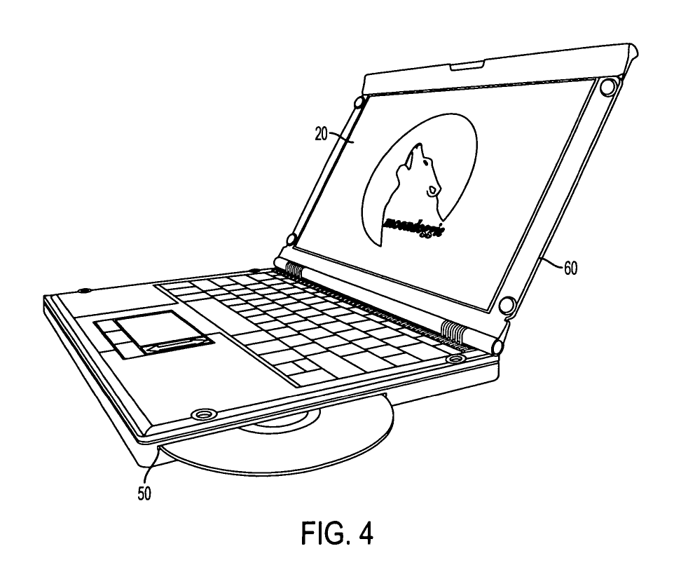

FIG. 4 shows another embodiment of the present invention in which the removable multi-function wireless digitizer tablet 60 is attached to the rear of the transparent LCD 20 configuration. Additionally, FIG. 4 shows a CD/DVD drive 50 located within the notebook computer base 30. The embodiment resembles a typical notebook computer.

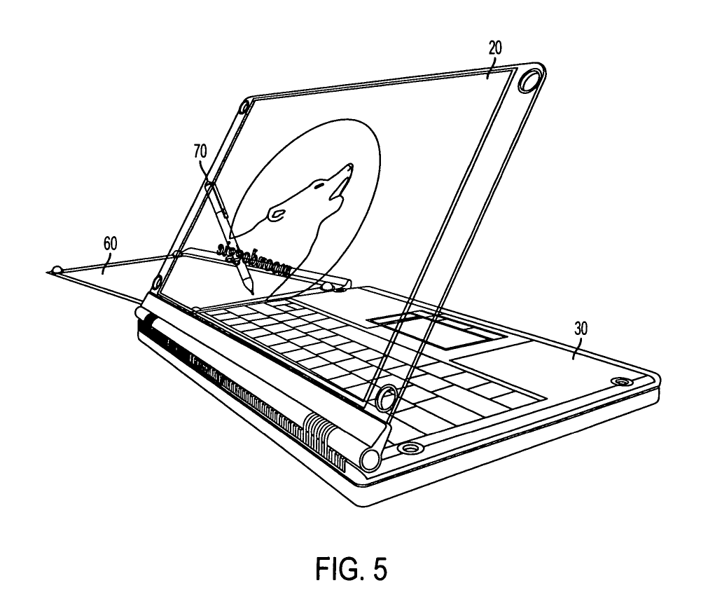

FIG. 5 shows one embodiment of the present invention. A mobile computer is provided that includes a notebook computer base 30 coupled with a transparent LCD configuration 20, wherein the removable multi-function wireless digitizer tablet 60 is detached from the transparent LCD configuration 20 and detached from the computer base 30. The removable multi-function wireless digitizer tablet 60 may communicate with the computer base 30 via wireless circuitry located within the removable multi-function wireless digitizer tablet 60 and the notebook computer base 30. In this embodiment the removable multi-function wireless digitizer tablet 60 is detached from the back of the transparent LCD configuration 20 exposing the backside of the transparent LCD configuration 20, wherein the transparent LCD configuration 20 displays an image on a first viewing side and a second viewing side such that the image is simultaneously viewable by viewers situated on opposite sides of the display device, wherein the viewed image may be inverted around a vertical axis. Furthermore, the transparent LCD configuration 20 optimally utilizes ambient light to illuminate the display and the transparent LCD configuration 20 may also be illuminated with illumination sources located within the transparent LCD enclosure.

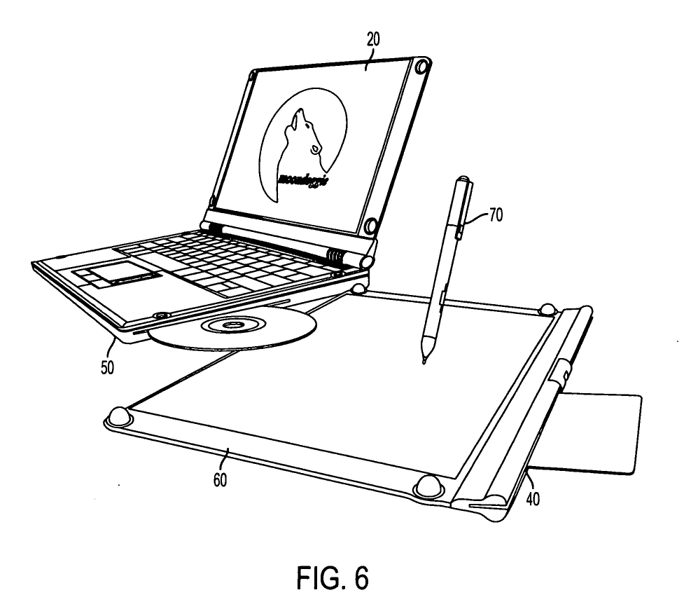

Another embodiment of the present invention is shown in FIG. 6. A mobile computer wherein the removable multi-function wireless digitizer tablet 60 is detached from the rear of the transparent LCD 20 configuration. The removable multi-function wireless digitizer tablet 60 appears in front of the notebook computer base and illustrates an integrated magnetic stripe reader 40 for credit/debit card processing and a stylus 70. The stylus 70 may be used in conjunction with the removable wireless digitizer tablet 60 to control or manipulate the mobile computer. The removable wireless digitizer tablet 60 may be used anywhere within the range of the wireless technology used to communicate with a computer. Furthermore, a CD/DVD drive 50 is shown integrated into the notebook computer base.

LCDs in use may be back-lit LCDs or front-lit LCDs. In back-lit LCDs, the light source directed through the LCD is a back-light assembly assembled behind the display; back lighting generally provides a more uniform image. A front-lit LCD, on the other hand, comprises a reflector assembled behind the LCD which reflects ambient light from reaching the reflector through the LCD. Some LCDs utilize ambient light to illuminate the display and make visible the images created by the LCD.

In a specific embodiment, the transparent screen may be illuminated by ambient light, by a backlight, by illumination sources on the frame of the screen, or by a combination of any of the light sources indicated earlier.

Electronic video and control signals may be received from a system, including, but not limited to a computer system, and transmitted through a device driver to the LCD screen. In yet another embodiment, the image on the screen may be flipped around the vertical axis. The image reformatting including changes in dimensions and orientation may be accomplished by the device driver(s).

An embodiment of the present invention may provide, for example, a mobile computer is provided that includes a notebook computer base coupled with a transparent LCD, wherein the transparent LCD is coupled with a removable multi-function wireless digitizer tablet, wherein the removable multi-function wireless digitizer tablet is positioned between the notebook computer base and the transparent LCD. The said configuration may resemble a typical slate tablet computer or may resemble a typical convertible tablet computer when the convertible tablet computer is positioned to resemble a slate tablet computer. The removable multi-function wireless digitizing tablet may be held in place with magnets. While in slate tablet mode, a stylus may be used on the screen activating the digitizing tablet beneath, thus allowing the user to manipulate data, draw, and generally use the tablet computer like any other tablet computer. The removable multi-function wireless digitizer tablet may be recharged, for example, through connections with the computer base that charge batteries in the removable multi-function wireless digitizer tablet.

When the tablet computer is positioned as a notebook computer, the removable multi-function wireless digitizer tablet may be removed from the mobile computer, and the computer generally operates like a standard notebook computer. While positioned as a notebook computer, a user may use the stylus directly on the removable multi-function wireless digitizer tablet. Thus, the removable multi-function digitizer tablet, for example, may communicate with the computer base via a wireless communication protocol like wireless USB (SPI) or Bluetooth technology. While in notebook mode, the digitizer tablet may, for example, control the tablet computer from a distance through the wireless circuitry. While positioned, the transparent LCD configuration may also be viewed from both sides. The LCD may be illuminated with ambient light, for example sunlight, or with the artificial illumination sources integrated into the LCD panel. The transparent screen may also be viewed from both sides of the screen. Those viewing the display from the backside view a horizontally inverted image. For presentation to others, a user may, for example, elect to flip the image around a vertical axis so that the image viewed from the back is not inverted.

The tablet computer of the present invention, while positioned as a typical notebook computer, may provide a number of advantages over conventional notebooks and tablet computers. For example, the removable multi-function wireless digitizer tablet may be used at a distance to control the host computer by communicating with the computer base with wireless circuitry. The screen is transparent and may be viewed from both the front and the back for more convenient viewing by an audience.

The removable multi-function wireless digitizer tablet may also include a credit card reader. A credit card reader may, for example, be used to accept point of sale purchases and the digitizer tablet may be used for signatures for these credit card payments. The removable multi-function digitizer tablet may also include an integrated video camera. The digitizing tablet may also include a digital stylus for input onto the digitizing tablet. A mobile computer may incorporate software with handwriting recognition, signature capture, stylus navigation, and other software applications.

A mobile computer may include standard notebook (laptop), or tablet computer components. For example, the mobile computer may include, but is not limited to, at least one of the following: a CPU, GPU, RAM, a hard drive (HD), integrated Wi-Fi, Ethernet adapters, IEEE 1394a ports, USB ports, wireless USB, Bluetooth, DVD player and/or recorder, CD player and/or recorder, PCMCIA slots, PCI Express, power supply, a keyboard, and any other standard notebook or tablet computer component. The mobile computer may also include outputs to external devices such as a television, smart phones, cameras, video recorders, projectors, or external monitors.

In a specific embodiment, the mobile computer incorporates a Intel Centrino 915 GM 2 GHz-Front Side Bus 533 MHz, integrated Intel Extreme Graphics processor, 512 MB DDR SDRAM expandable up to 2 GB (2 SO-DIMM), 80.0 GB Hard Drive, integrated Wi-Fi (802.11 b/g), PCMCIA for PC Cards type I/II, standard Wireless AirCard or wireless wide area network (WWAN) card for GSM/GPRS or PCS networks, integrated 10/100 Ethernet (802.3) LAN, integrated USB 2.0, WUSB, integrated FireWire (IEEE 1394), integrated Bluetooth (v.1.1), and an integrated DVD±R/±RW CD-R/RW Drive.

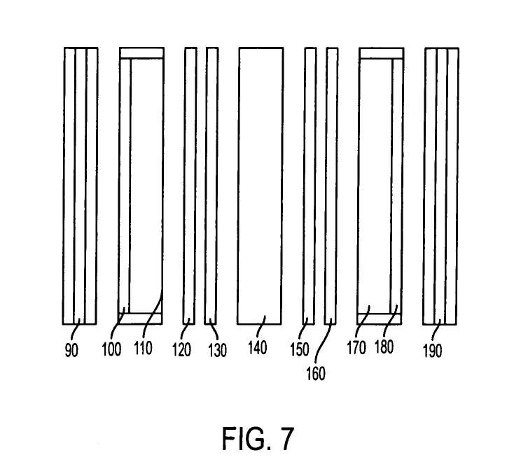

Referring to FIG. 7, in a specific embodiment, the display device comprises a first enclosure (not shown) such as a clear, Lexan-like enclosure, a first polarizer retardation film 90 with half wave mirror with the mirror reflectance from 15 to 60 percent such as a polarizer retardation film as manufactured by ALP, Inc., a first diffusion surface or diffractive surface or element 100 with surface haze between 0 to 30 percent, a first optical grade plastic 110 with Cold Cathode Florescent Lamp (CCFL) or Light Emitting Diodes (LEDs) surrounding the circumference of the optical grade plastic, a second diffusion surface 120 with surface haze between 0 to 60 percent, a first transflective film 130 such as a transflective film as manufactured by ALP, Inc., a LCD panel 140, a second transflective film 150 such as a transflective film as manufactured by ALP, Inc., a third diffusion surface 160 with surface haze between 0 and 60 percent, a second optical grade plastic 170 with Cold Cathode Florescent Lamp (CCFL) or Light Emitting Diodes (LEDs) surrounding the circumference of the optical grade plastic, a fourth diffusion surface or diffractive surface or element 180 with surface haze between 0 and 30 percent, a second polarizer retardation film 190 with half wave mirror with the mirror reflectance between 15 and 60 percent such as a polarizer retardation film as manufactured by ALP, Inc., and a second enclosure (not shown) such as a clear, Lexan-like enclosure.

The LCD displays of the present invention preferably optimally utilize ambient light to illuminate the display.

The transparent LCD configuration of the present invention may be utilized in any relevant or desired application, including utilization with notebook/tablet computers, cellular phones, personal digital assistants or other accessories including, but not limited to, cash registers, store windows, and electronic games benefiting from a transparent screen which displays an image viewable from opposing sides and a device which optimally utilizes ambient light to illuminate the display.

In a specific embodiment, one or more photo sensors (not shown) are located, at different positions, preferably adjacent to the edges of the transparent screen, and most preferably on both sides of the screen. The photo sensors detect the amount of ambient light and generate an output signal, preferably at regular intervals, responsive to the amount of ambient light present. Driver circuitry (not shown) coupled to the photo sensors, accordingly, in one embodiment, adjusts the back lighting to optimize the use of ambient light for illumination of the display and to maximize battery life by reducing the consumption of power by the back-lighting assembly. The optimization function of the use of ambient light in the present invention may be in concert with default lighting settings provided with the screen or user-adjustable brightness or contrast settings for the screens of the present invention.

The driver circuitry coupled to one or more photo sensors controls and adjusts the back lighting in accordance with the amount of ambient light detected by the photo sensors. The driver adjusts the LCD panel illumination according to default lighting settings or user-adjustable brightness or contrast settings for the screen. For example, if the screen is used outdoors under the sun on a sunny day, the LCD panel is illuminated using ambient light and the back lighting is dimmed by the device driver. On the other hand, if the screen is used outdoors on a cloudy day or is used indoors, wherein the ambient light is insufficient, the LCD panel is illuminated using both ambient light and artificial lighting, wherein the artificial lighting is switched on by the device driver and the driver circuitry. Thus, the device driver and driver circuitry maximizes the use of ambient light for illuminating the LCD screen and thereby, maximizes the consumption of battery power by reducing the consumption of power for back lighting.

In one specific embodiment, the driver circuitry comprises a control system (not shown) for processing of signals. The one or more photo sensors generate an analog voltage signal proportional to the amount of ambient light. The photo sensors generate a higher voltage signal if the screen is used outdoors under the sun on a sunny day than if the screen is used outdoors on a cloudy day or is used indoors. The generated voltage signal is transmitted to the control system which is coupled electrically to the photo sensors. If multiple photo sensors are used, a single output photo sensor voltage signal is generated by combining the several voltage signals by computing the average, root mean square or any other user-determined value. The output photo sensor voltage signal is then compared against a reference voltage value set by default lighting settings or user-adjustable brightness or contrast settings for the screens. If the output photo sensor voltage signal exceeds the reference voltage value, the control system sends an output signal to the back lighting assembly to reduce the illumination of the LCD panel by back lighting. On the other hand, if the output photo sensor voltage signal is lower than the reference voltage value, the control system sends an output signal to the back lighting assembly to increase the illumination of the LCD panel by back lighting.

In another embodiment, the driver circuitry comprises a control system (not shown) for processing of signals. The one or more photo sensors generate an analog voltage signal proportional to the amount of ambient light. The photo sensors generate a higher voltage signal if the screen is used outdoors under the sun on a sunny day than if the screen is used outdoors on a cloudy day or is used indoors. An analog-to-digital converter converts the analog signal to a digital signal. The digital signal is transmitted to the control system which is coupled electrically to the photo sensors. If multiple photo sensors are used, a single output photo sensor voltage signal is generated by combining the several voltage signals by computing the average, root mean square or any other user-determined value. The output photo sensor voltage signal is then compared against a reference voltage value set by default lighting settings or user-adjustable brightness or contrast settings for the screens. If the output photo sensor voltage signal exceeds the reference voltage value, the control system sends an output signal to the back lighting assembly to reduce the illumination of the LCD panel by back lighting. On the other hand, if the output photo sensor voltage signal is lower than the reference voltage value, the control system sends an output signal to the back lighting assembly to increase the illumination of the LCD panel by back lighting.

What is claimed is:

1. A transparent screen comprising:
a first enclosure;
a first polarizer retardation film with half wave mirror;
a first diffusion surface, or diffractive surface or element;
a first optical grade plastic with Cold Cathode Florescent Lamp (CCFL) or Light Emitting Diodes (LEDs) surrounding the circumference of the optical grade plastic;
a second diffusion surface;
a first transflective film;
a LCD panel;
a second transflective film;
a third diffusion surface;
a second optical grade plastic with Cold Cathode Florescent Lamp (CCFL) or Light Emitting Diodes (LEDs) surrounding the circumference of the optical grade plastic;
a fourth diffusion surface, or diffractive surface or element;
a second polarizer retardation film with half wave mirror, and
a second enclosure.
wherein the first polarizer retardation film is positioned between the first enclosure and the first diffusion surface; the first diffusion surface is positioned between the first polarizer retardation film and the first optical grade plastic; the first optical grade plastic is positioned between the first diffusion surface and the second diffusion surface; the second diffusion surface is positioned between the first optical grade plastic and the first transflective film; the first transflective film is positioned between the second diffusion surface and the LCD panel; the LCD panel is positioned between the first transflective film and the second transflective film; the second transflective film is positioned between the LCD panel and the third diffusion surface; the third diffusion surface is positioned between the second transflective film and the second optical grade plastic; the second optical grade plastic is positioned between the third diffusion surface and the fourth diffusion surface; the fourth diffusion surface is positioned between the second optical grade plastic and the second polarizer retardation film; the second polarizer retardation film is positioned between the fourth diffusion surface and the second enclosure; and the elements are all connected together.

2. The transparent screen of claim 1, wherein the first enclosure comprises a clear, Lexan-like enclosure.

3. The transparent screen of claim 1, wherein the second enclosure comprises a clear, Lexan-like enclosure.

4. The transparent screen of claim 1, wherein the mirror reluctance of the half wave mirror of the first polarizer retardation film is at least about 15 percent.

5. The transparent screen of claim 1, wherein the mirror reluctance of the half wave mirror of the second polarizer retardation film is at least about 15 percent.

6. The transparent screen of claim 1, wherein the surface haze of the first diffusion surface or diffractive surface or element is at most about 30 percent.

7. The transparent screen of claim 1, wherein the surface haze of the second diffusion surface is at most about 60 percent.

8. The transparent screen of claim 1, wherein the surface haze of the third diffusion surface is at most about 60 percent.

9. The transparent screen of claim 1, wherein the surface haze of the fourth diffusion surface or diffractive surface or element is at most about 30 percent.

10. The transparent screen of claim 1, wherein the transparent screen is illuminated with ambient light.

11. The transparent screen of claim 1, wherein the transparent screen comprises illumination sources on the sides, top, and bottom of the transparent screen for screen illumination.

12. The transparent screen of claim 1, wherein the transparent screen is illuminated with illuminations sources on the edges of the transparent screen, ambient light, and a backlight illumination surface.

13. The transparent screen of claim 1, wherein an image on the screen can be viewed on both sides of the transparent screen.

14. The transparent screen of claim 1, wherein the image on the transparent screen may be transposed around the vertical axis.

15. The transparent screen of claim 1, further comprising one or more photo sensors.

16. The transparent screen of claim 15, wherein the photo sensors are located at different positions on the transparent screen.

17. The transparent screen of claim 16, wherein the photo sensors are located adjacent to the edges of the transparent screen.

18. The transparent screen of claim 15, wherein the photo sensors are located on both sides of the transparent screen.

19. The transparent screen of claim 15, further comprising a control system for processing of signals from the photo sensors.

20. The transparent screen of claim 19, further comprising an analog-to-digital converter which converts the analog signal from the photo sensors to a digital signal.

21. A removable multi-function wireless digitizer tablet comprising:
a digitizing surface;
a stylus; and
wireless communication circuitry,
wherein the wireless communication circuitry communicates with a computer.

22. The removable wireless digitizer tablet of claim 21, further comprising an illumination source, wherein the illumination source and the digitizing surface are coterminous.

23. The removable wireless digitizer tablet of claim 21, wherein the removable wireless digitizer tablet further comprises one or more of the group consisting of a camera and a credit card reader.

24. The removable wireless digitizer tablet of claim 21, wherein the wireless circuitry is selected from the group consisting of Bluetooth and Wireless Universal Serial Bus (WUSB).

25. The removable wireless digitizer tablet of claim 21, wherein the removable wireless tablet is constructed of carbon fiber.

26. A digitizer tablet computer comprising:
a computer base; the transparent screen of claim 1; and the removable wireless digitizer tablet of claim 21,
wherein the wireless communication circuitry communicates with the computer base; and
wherein the computer base, the transparent screen, and the removable wireless digitizing tablet are coupled together in two modes selected from the group consisting of tablet mode and laptop mode.

27. The digitizer tablet computer of claim 26, wherein the computer base comprises a processor; a memory storage device; and wireless communication circuitry.

28. The digitizer tablet computer of claim 26, wherein the laptop mode comprises an edge of the transparent screen coupled with an edge of the computer base; and the removable wireless digitizer tablet is uncoupled from the transparent screen and the computer base and the removable wireless digitizer tablet communicates via the wireless communication circuitry.

29. The digitizer tablet computer of claim 26, wherein the laptop mode comprises an edge of the transparent screen coupled with an edge of the computer base; and the removable wireless digitizer tablet is coupled on the top of the transparent screen and acts as an illumination source for the transparent screen.

30. The digitizer tablet computer of claim 26, wherein the tablet mode comprises the removable wireless digitizer tablet between the transparent screen and the computer base; wherein the removable wireless digitizer tablet provides back light for the transparent screen.

31. The digitizer tablet computer of claim 26, wherein the removable wireless digitizer tablet further comprises one or more of the group comprising a camera and a credit card reader.

32. The digitizer tablet computer of claim 26, wherein the wireless communication circuit is selected from the group consisting of Bluetooth and Wireless Universal Serial Bus (WUSB).

33. The digitizer tablet computer of claim 26, wherein the removable wireless digitizer tablet is constructed of carbon fiber.

34. The digitizer tablet computer of claim 28, wherein the transparent screen is illuminated by ambient light when uncoupled.

35. The transparent screen of claim 26, wherein the transparent screen is illuminated with illuminations sources on the edge of the transparent screen, ambient light, and a backlight illumination surface.

36. The digitizer tablet computer of claim 26, wherein the removable wireless digitizer tablet is magnetically coupled with the transparent screen.

37. The digitizer tablet computer of claim 26, further comprising an output to an external device selected from the group consisting of televisions, smart phones, projectors, and external monitors.

38. A method of using the digitizer tablet computer of claim 26, comprising uncoupling the removable wireless digitizer tablet from the digitizer tablet computer and using the removable wireless digitizer tablet to interact with the digitizer tablet computer from a distance via wireless communication.

39. A method of using the digitizer tablet computer of claim 26 comprising presenting an image on the transparent screen wherein the image is viewed from both sides of the screen.

40. A method of using the digitizer tablet computer of claim 31 comprising accepting credit card payments via the credit card reader and accepting signatures for the credit card payments via the removable wireless digitizing tablet.

41. A method of using the digitizer tablet computer of claim 26 comprising converting the image on the transparent display by flipping the image around a vertical image.

42. A method of displaying an image on each side of a transparent LCD screen comprising the steps of:
generating an image on the transparent screen of claim 1, wherein the image is generated by activating a given set of pixels on the LCD screen using a LCD driver.

43. The method of claim 42, wherein the step of generating images further comprises the step of displaying an image on the first viewing side and a reformatted image on the second viewing side, wherein the reformatted image comprises the image of different dimensions and orientation.

44. The method of claim 42, further comprising optimizing the use of ambient light to illuminate the LCD screen.

45. The method of claim 42, wherein the transparent screen further comprises one or more photo sensors.

46. The method of claim 45, wherein the photo sensors are located at different positions on the transparent screen.

47. The method of claim 46, wherein the photo sensors are located adjacent to the edges of the transparent screen.

48. The method of claim 45, wherein the photo sensors are located on both sides of the transparent screen.

49. The method of claim 45, further comprising a control system for processing of signals from the photo sensors.

50. The method of claim 49, wherein the photo sensors generate an analog voltage signal proportional to the amount of ambient light.

51. The method of claim 50, wherein the photo sensors generate a higher voltage signal if the screen is used outdoors under the sun on a sunny day than if the screen is used outdoors on a cloudy day or is used indoors.

52. The method of claim 50, further comprising an analog-to-digital converter which converts the analog signal from the photo sensor to a digital signal.

53. The method of claim 52, wherein the digital signal is transmitted to the control system which is coupled electrically to the photo sensors.

54. The method of claim 50, wherein if more than one of the photo sensors are used, a single output photo sensor voltage signal is generated by combining the several voltage signals of the more than one photo sensors by computing the average, root mean square or any other user-determined value.

55. The method of claim 50, wherein the output photo sensor voltage signal is then compared against a reference voltage value set by default lighting settings or user-adjustable brightness or contrast settings for the transparent screen.

56. The method of claim 55, wherein if the output photo sensor voltage signal exceeds the reference voltage value, the control system sends an output signal to the back lighting assembly to reduce the illumination of the transparent screen.

57. The method of claim 55, wherein if the output photo sensor voltage signal is lower than the reference voltage value, the control system sends an output signal to increase the illumination of the transparent screen.

58. A method for controlling the use of ambient light in a transparent screen comprising the steps of:
adjusting the illumination of the transparent screen of claim 15, wherein the adjusting comprises converting an analog signal from the photo sensor to a digital signal, wherein the digital signal is transmitted to a control system which is coupled electrically to the photo sensors, and wherein the digital signal is then compared against a reference voltage value set by default lighting settings or user-adjustable brightness or contrast settings for the transparent screen, and wherein if the digital signal exceeds the reference voltage value, the control system sends an output signal to reduce the illumination of the transparent screen, or wherein if the output photo sensor voltage signal is lower than the reference voltage value, the control system sends an output signal to increase the illumination of the transparent screen.

59. The method of claim 58 wherein if more than one of the photo sensors are used, a single output photo sensor voltage signal is generated by combining the several voltage signals of the more than one photo sensors by computing the average, root mean square or any other user-determined value.
